(19) United States
(12) Patent Application Publication
(10) Pub. No.: US 2012/0173382 A1
(43) Pub. Date: Jul. 5, 2012

(54) METHODS AND SYSTEMS FOR LIGHTING ATMOSPHERE MARKETPLACE

(75) Inventor: Damien Loveland, Briarcliff Manor, NY (US)

(73) Assignee: KONINKLIJKE PHILIPS ELECTRONICS N.V., EINDHOVEN (NL)

(21) Appl. No.: 13/395,658

(22) PCT Filed: Aug. 26, 2010
(86) PCT No.: PCT/IB2010/053855

§ 371 Date: Mar. 13, 2012

(30) Foreign Application Priority Data
Sep. 21, 2009 (US) 61244125
Nov. 23, 2009 (US) 61263595

(51) Int. Cl. G06Q 30/00; G06Q 30/06

(52) U.S. Cl. 705/26.5; 705/26.1

(57) ABSTRACT

Systems and methods for creating a marketplace of lighting atmosphere settings related to at least one controllable lighting network are disclosed. The systems include a processor that can be used in conjunction with a personal communication device and a preferences database. The processor is used to detect a user identifier, a user input associated with a set of lighting atmosphere settings, and optionally a context corresponding to the user identifier. The processor in some such systems has an associated local memory to store the user input, the set of lighting atmosphere settings, and the identifier of the associated user. The processor is further used to identify a setting identifier associated with the set of lighting atmosphere settings from a preference database. The processor is also used to provide or approve a payment for the value of the set of lighting atmosphere settings to the marketplace. In exchange for the payment, the processor retrieves the set of lighting atmosphere settings using the setting identifier. The preferences database in some such systems is used to store the setting identifiers, the user input and the associated user identifiers.

### CROSS-REFERENCE TO RELATED APPLICATIONS

This application claims, under 35 U.S.C. 119(e), priority to and benefit of U.S. provisional applications Ser. Nos. 61/263,595 and 61/244,125, filed on Nov. 23, 2009, and Sep. 21, 2009, respectively.

### FIELD OF THE INVENTION

The present invention is directed generally to controllable networks and related communications. More particularly, various embodiments of the present invention are directed to systems and apparatus for selecting, retrieving, and/or modifying lighting atmosphere settings in controllable lighting networks.

### BACKGROUND OF THE INVENTION

Digital lighting technologies, i.e. illumination based on semiconductor light sources, such as light-emitting diodes (LEDs), offer a viable alternative to traditional fluorescent, HID, and incandescent lamps. LEDs are semiconductor-based light sources traditionally employed in low-power instrumentation and appliance applications for indication purposes. Functional advantages and benefits of LEDs include high energy conversion and optical efficiency, durability, lower operating costs, and many others.

Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects. This color variety of LEDs has been recently exploited to create novel LED-based light sources having sufficient light output for new space-illumination and direct view applications. For example, as discussed in U.S. Pat. No. 6,016,038, incorporated herein by reference, multiple differently colored LEDs may be combined in a lighting fixture having one or more internal microprocessors, wherein the intensity of the LEDs of each different color is independently controlled and varied to produce a number of different hues.

In one example of such an apparatus, red, green, and blue LEDs are used in combination to produce literally hundreds of different hues from a single lighting fixture. Additionally, the relative intensities of the red, green, and blue LEDs may be computer controlled, thereby providing a programmable multi-channel light source, capable of generating any color and any sequence of colors at varying intensities and saturations, enabling a wide range of eye-catching lighting effects. Such LED-based light sources have been recently employed in a variety of fixture types and a variety of lighting applications in which variable color lighting effects are desired. Lighting systems employing multiple light sources, and the effects they produce, can be controlled and coordinated through a network, wherein a data stream containing packets of information representing lighting commands is communicated to the lighting devices. Each of the lighting devices may register all of the packets of information passed through the system, but only respond to packets that are addressed to the particular device. Once a properly addressed packet of information arrives, the lighting device may read and execute the lighting commands. Based on the network controllability of such lighting systems, lighting programs may be authored for these systems which, when executed, generate a wide variety of lighting effects or “lighting shows” in any of a number of different environments.

In general, a “lighting effect” refers to one or more states of light that are perceived as an entity over some period of time. A lighting effect may include a single color of light (including generally white light) or multiple colors of light perceived simultaneously and/or in some sequence. A lighting effect may have one or more static and/or dynamic characteristics, and exemplary dynamic characteristics may relate to one or more of color, brightness, perceived transition speed, perceived motion, periodicity, and the like. A “lighting show” may comprise a single lighting effect having some finite duration that is executed once, repeated periodically in some prescribed fashion, or repeated indefinitely. A lighting show also may comprise a number of different lighting effects executed in sequence or simultaneously according to a wide variety of definable parameters. Lighting effects constituting a lighting show also may be packaged as “meta-effects” that include multiple temporally linked lighting effects. One or more lighting effects, or an entire lighting show, may be based on parameters that are definable by a designer/programmer, or based at least in part on predefined (“prepackaged”) lighting effects available for selection by the designer/programmer during the authoring process. Additionally, all or a portion of a lighting effect or lighting show may be based on graphics or animation data, as well as video signals, that are converted to lighting control information pursuant to designer/programmer instructions provided during the authoring process.

While advances in digital lighting technologies have given rise to precisely controllable lighting, the known systems for lighting effects or lighting shows need to be authored by a designer/programmer via a graphical user interface (GUI) coupled to one or more processors/computers which collectively serve as a “light system composer.” Exemplary methods and systems for authoring lighting effects or shows are discussed in U.S. Pat. No. 7,139,617, and U.S. Patent Application Publication No. US-2005-0248299-A1, both of which are incorporated herein by reference. As discussed in these references, a lighting effect or lighting show may be encoded as a sequential list of lighting states and transitions between lighting states, or frames of color data with reference to a time base, as a lighting program, which is then communicated to a lighting controller; the lighting controller in turn may be configured to generate lighting commands for execution by one or more lighting units based on the lighting program representing the lighting effect or lighting show.

A well-designed lighting in a space with the appropriate settings can result in a much more impressive ambience than one would otherwise get. However, when designing the ambience of such space, lighting is often allocated to a minimal budget. The space owners may be willing to install lighting systems, but they may not be interested in hiring professional help from a lighting designer, interior designer or architect because they may not want to expend the necessary amount of money or time required for working with, for example, a lighting designer. Yet, without the professional input of a lighting designer, it can be difficult to achieve effective lighting settings let alone creating lighting effects or lighting shows. Therefore, the current problem lies in the need for the space owners to receive effective lighting atmospheres while remunerating the creators or designers of such effective atmospheres without directly working with one.

Although the fields of mobile devices and digital or solid-state lighting have seen great advances, systems that combine the use of controllable solid state lighting and personal mobile devices to further enrich retrieving lighting atmosphere settings from different spaces and adjusting lighting of one space based on the retrieved lighting atmosphere settings across a lighting network are lacking. For example, in systems adjusting the lighting of a space based on the lighting atmosphere settings from other spaces, the space owner generally (1) needs to hire a lighting designer to initially manually design a lighting setting similar to the ones from other spaces, and (2) manually enter every single lighting setting to create the preferred lighting atmosphere setting.

Moreover, in addition to the lighting designers who work with lighting, there are other artists who create images using lighting. For instance, light throwies are an example of using light as a medium for art, in which LEDs connected to a small battery and magnet are thrown onto a magnetic surface for the purpose of creating non-destructive graffiti and light displays. However, an image using light as its medium may not be viewed by many people and its lifetime may be very short. Therefore, there is a need for providing a facility to save images created using light and distribute such images to as many viewers as possible. Further, the current systems lack a capability for streaming a revenue opportunity for these artists or designers for displaying or sharing their work.

### SUMMARY OF THE INVENTION

Applicant herein generally recognized and appreciated that there is a need in the art to combine advances made in controllable lighting technology with advances made in communications technology, because conventional solutions in the fields of lighting control and the electronic communications do not fully leverage advantages provided by the advances in both fields, choosing instead to focus on one at the exclusion of the other. Applicant, however, further appreciated that a combination of controllable lighting and electronic communications technologies has the capacity to provide particularly advantageous solutions in a multitude of circumstances where technology operating alone is not fully leveraged.

Applicant specifically recognized a need in the art for systems, methods, and apparatus for retrieving lighting atmosphere settings of a venue without requiring that the designer of those lighting atmosphere settings or any other lighting designer be hired to design similar lighting atmosphere settings in a new space. In particular, no system currently known to the Applicant permits a user to identify lighting atmosphere settings of a venue, retrieve such settings from the venue, and provide payment to or approve payment of the venue in exchange of the retrieval. Applicant recognized that if a system were permitted to retrieve lighting atmosphere settings from venues, then such lighting atmosphere settings can be duplicated more quickly and less expensively at other venues while still rewarding the lighting designers of the lighting atmosphere settings being retrieved for their work. Thus, there is an unfulfilled need in the art for systems, methods, and apparatus for trading lighting atmosphere settings in exchange of payment. Accordingly, the present disclosure generally relates to systems and apparatus for retrieving lighting atmosphere settings related to controllable lighting networks and modifying lighting based on the retrieved lighting atmosphere settings and for using communications technology to pay for the transaction.

Generally, in one aspect, the invention focuses on a system for creating a marketplace of lighting atmosphere settings related to at least one controllable lighting network. The system includes at least one processor, a schematizer, and a marketplace. The at least one processor is configured to execute an awareness module and an executive module. The awareness module detects a user identifier and a user input associated with a set of lighting atmosphere settings. The executive module transmits the user identifier and the user input from the awareness module to the schematizer. The schematizer is configured to upload the set of lighting atmosphere settings and a setting identifier associated with the set of lighting atmosphere settings to the marketplace. The marketplace is configured to store the user identifier and to enable retrieval of the set of lighting atmosphere settings in exchange for a payment.

In some embodiments of the foregoing aspect of the invention, the schematizer is also configured to retrieve personal preferences associated with the user identifier from a preference database to control the set of lighting atmosphere settings based on the personal preferences. In other embodiments of the invention, the schematizer may also be configured to provide a schema to the executive engine controlling the set of lighting atmosphere settings. In some such embodiments, the schema runs in the executive module. In another embodiment of the invention, the schematizer sends the user identifier and the setting identifier to a preference database. The awareness module may further detect a context corresponding to the user identifier, and the executive module further transmits the context from the awareness module to the schematizer.

Generally, in another aspect, the invention focuses on a method for creating a marketplace of lighting atmosphere settings in a controllable lighting network. The network includes at least one memory for storing data and instructions, a lighting source, a schematizer, at least one processor. The at least one processor is configured to access the at least one memory and to execute at least one software module, an awareness module. The system is configured to perform the steps of: detecting, by an awareness module, a user identifier and a user input associated with the user identifier, the user input changing a value for a set of lighting atmosphere settings; and uploading, by the schematizer, a setting identifier associated with the set of lighting atmosphere settings to a marketplace, the set of lighting atmosphere settings available in exchange for a payment of the value.

According to some embodiments of the invention, the processor further performs the steps of storing the user identifier and the setting identifier in the marketplace for providing an option for retrieval. In other embodiments of the invention, the processor further performs the steps of storing the user identifier, the user input and the setting identifier in a preference database. In another embodiment of the invention, the processor also performs receiving personal preferences associated with the user identifier and allows control of the set of lighting atmosphere settings based on the personal preferences.

Yet another aspect of the present invention is a method for retrieving lighting atmosphere settings in a controllable lighting network comprising at least one memory for storing data and instructions, a user interface, a lighting source, a schematizer, at least one processor. The processor is configured to access the at least one memory and to execute a plurality of software modules. The plurality of software modules comprise an awareness module. The method includes the computer-implemented steps of detecting, by the awareness module, a user identifier and a user input associated with the user identifier and with a set of lighting atmosphere settings having a value; identifying, by the schematizer, a setting identifier associated with the set of lighting atmosphere settings from a preference database; approving, by the schematizer, a payment for the value of the set of lighting atmosphere settings; and retrieving, by the schematizer, the set of lighting atmosphere settings using the setting identifier. According to some embodiments of the invention, the marketplace takes a portion of the payment as a transfer fee.

According to still another aspect of the present invention, a method for modifying lighting atmosphere settings in a controllable lighting network is detecting a vote from a user, the vote associated with a first set of lighting atmosphere settings of a first venue, receiving from the user an input representing a second set of lighting atmosphere settings of a second venue having a value, retrieving a setting identifier associated with the second set of lighting atmosphere settings from a preference database, transferring a payment of the value from the first venue to the second venue, retrieving the second set of lighting atmosphere settings using the setting identifier from the marketplace, and modifying the first set of lighting atmosphere settings based on the second set of lighting atmosphere settings. The controllable lighting network comprises at least one memory for storing data and instructions, a user interface, a lighting source, and at least one processor configured to access the at least one memory and to execute a plurality of software modules, comprising an awareness module and an executive module.

Moreover, many aspects of the present invention involve retrieving lighting atmosphere settings for a venue in a controllable lighting network comprising at least one memory for storing data and instructions, a user interface, a lighting source, a schematizer, and at least one processor configured to access the at least one memory and to execute a plurality of software modules, comprising an awareness module and an executive module. The plurality of software modules are configured for detecting, by the awareness module, at least one user identifier of at least one user visiting the venue; retrieving, by the schematizer, at least one lighting setting vote associated with the at least one user identifier from a preference database; identifying, by the schematizer, a set of lighting atmosphere settings for the venue based on the at least one lighting setting vote, the set of lighting atmosphere settings having a value; retrieving, by the schematizer, a setting identifier associated with the set of lighting atmosphere settings from the preference database; approving, by the schematizer, a payment for the value of the set of lighting atmosphere settings to a marketplace; and retrieving, by the schematizer, the set of lighting atmosphere settings from the marketplace using the setting identifier.

Yet another aspect of the present invention relates to a system for generating revenue from lighting-based images linked to a communication network. The system employs at least one processor configured to execute a display module, a transfer engine, and a payment engine. The display module displays a lighting-based image created by a first user. The transfer engine transmits the lighting-based image to a second user. The payment engine requests payment from the second user for the lighting-based image transmission. The system also comprises a memory which is configured to store the lighting-based image.

According to some embodiments of this aspect of the invention, the system also employs a communication link for the second user to request the lighting-based image. In some embodiments of the invention, the second user requests the lighting-based image to a mobile device. The second user may also request the lighting-based image to a personal communication account. In other embodiments of the invention, the second user has an account associated with a user signature, user logo or user tag, and the display module displays the user signature, user logo or user tag. Further, the memory stores the user signature, user logo or user tag. The display module could be Bluetooth enabled, and the second user downloads the image from the display module using the Bluetooth.

It should be appreciated that the foregoing concepts, alone and in various combinations (provided the combinations are not mutually inconsistent), as discussed in greater detail below are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

In the drawings, like reference characters generally refer to the same or similar parts throughout the different views. Also, the drawings are not necessarily to scale, emphasis instead generally being placed upon illustrating the principles of the invention.

FIG. 1 illustrates a plurality of controllable lighting networks with respect to each of which some embodiments of the invention may be derived and/or applied.

FIG. 2 illustrates an example of a user interface of an exemplary application for modifying lighting atmosphere settings consistent with an embodiment of the invention.

FIG. 3 illustrates another example of a user interface of an exemplary application for modifying lighting atmosphere settings consistent with an embodiment of the invention.

FIG. 4 illustrates an example of a flow diagram of an exemplary procedure for creating a marketplace for lighting atmosphere settings consistent with an embodiment of the invention.

FIG. 5 illustrates an example of a flow diagram of an exemplary procedure for retrieving lighting atmosphere settings consistent with an embodiment of the invention.

FIG. 6 illustrates an example of a flow diagram of an exemplary procedure for modifying lighting atmosphere settings consistent with an embodiment of the invention.

FIG. 7 illustrates an example of a flow diagram of an exemplary procedure for retrieving a lighting atmosphere setting based on previous votes consistent with an embodiment of the invention.

FIG. 8 illustrates an example of a flow diagram of an exemplary procedure for modifying a lighting atmosphere setting based on personal preferences consistent with an embodiment of the invention.

FIG. 9 illustrates an example of a flow diagram of an exemplary procedure for generating revenue for lighting-based images in a design system with a display screen according to some embodiments of the invention.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

Reference is now made in detail to illustrative embodiments of the invention, examples of which are shown in the accompanying drawings.

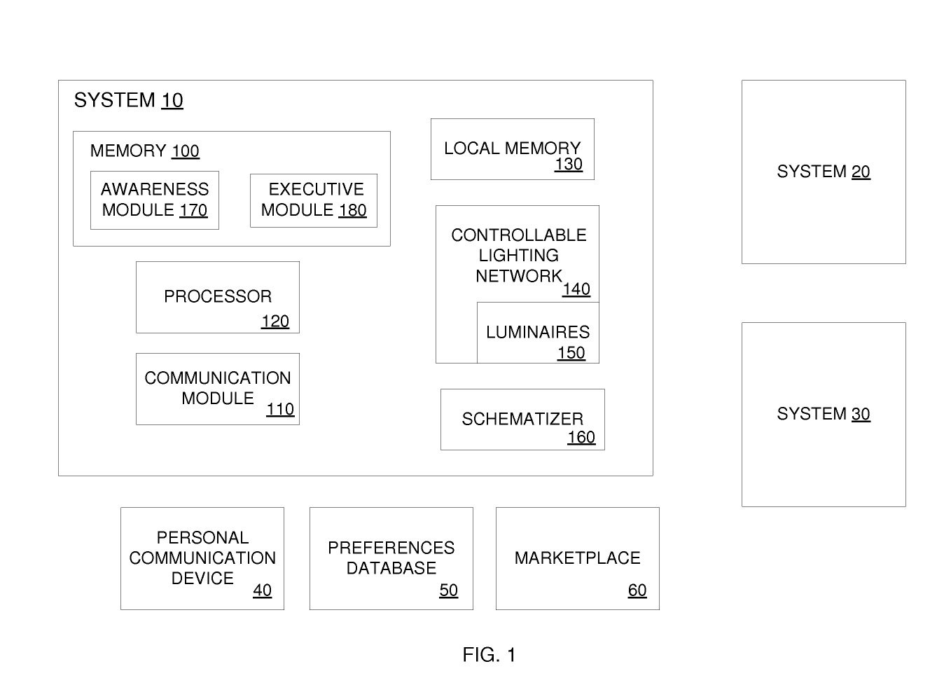

FIG. 1 illustrates an interactive system 10 suitable for use with various embodiments of the invention. Interactive system 10 includes a memory 100, a communication module 110, a processor 120, a local memory 130, and a controllable lighting network 140 including one or more individually controllable luminaires 150. A personal communication device (personal device) 40 can move in and out of, and interact with, interactive system 10. Any number of distinct personal devices, such as personal device 40, can be within interactive system 10, at any one time. Luminaires 150 in the controllable lighting network 140 can be manually adjusted through system 10. System 10 may store on local memory 130 any adjustments requested by a user. System 10 may further store on local memory 130 any preferences related to system 10 entered by the user. In interactive system 10, communication module 110 is used by processor 120 to communicate with personal device 40. Communication module 110 transmits a user identifier derived from personal device 40 to processor 120. In response to the user identifier, system 10 accesses information about the user from local memory 130 and may adjust luminaires 150 in the controllable lighting network 140 according to that information.

A preferences database 50 in accordance with the invention can be included within any one of the interactive systems 10, 20, 30 or can be remote from each of them. Preferences database 50 in embodiments of the invention is accessible to each of the interactive systems 10, 20, 30 via communication module 110 or another communications link (not shown). A personal communication device (personal device) 40 can move in and out of, and interact with, any one of the interactive systems 10, 20, 30 and any number of similar systems. Any number of distinct personal devices, such as personal device 40, can be within an interactive system, such as systems 10, 20, 30, at any one time. Although FIG. 1 illustrates three interactive systems, it should be understood that the present invention is useful with respect to any number of interactive systems.

Memory 100 includes an awareness module 170 and an executable module 180. In other embodiments of the present invention, the awareness module 170 and the executable module 180 may be located in local memory 130.

Processor 120 can be a component within a larger interactive system 10. Processor 120 may also control luminaires 150 in lighting network 140 by transmitting a control signal indicative of user's personal lighting preferences associated with user identifier. The term “processor” as used herein refers to any circuitry that processes arithmetic and logic instructions, such as a central processing unit of a computer capable of manipulating information. Embodiments of processor 120 include, but are not limited to, conventional microprocessors, application specific integrated circuits (ASICs), and field-programmable gate arrays (FPGAs). Although FIG. 1 illustrates processor 120 as a single processor, it should be understood that the present invention could be implemented as a plurality of processors 120-1, 120-2, . . . , 120-n (not shown) functioning cooperatively.

When executed by processor 120, awareness module 170 receives a signal indicative of a user identifier associated with personal device 40 from personal device 40. Exemplary embodiments of personal device 40 include a mobile phone, an SMS device, a personal digital assistant, a BLACKBERRY device, an IPHONE device, an IPOD device and a device including a programmable RFID tag. An “RFID tag” as used herein includes any object that can be incorporated into any other object in order that the object incorporating the RFID tag may be tracked using radio waves. In some embodiments, an RFID tag may contain at least two parts: a first part involving an integrated circuit for performing such functions as modulating and demodulating radio frequency signals, and a second part involving an antenna for receiving and transmitting radio-frequency signals. Additionally, an RFID tag may be passive or active. In some embodiments of system 10, personal device 40 may include a processor.

When executed by processor 120, awareness module 170 receives the signal from personal communication device 40 via communication module 110. Embodiments of communication module 110 may include, for example, a wired network, a wireless network, or a combination of different wired and wireless networks. Moreover, communication module 110 may involve different technologies, e.g., infrared communications, fiber optics communications, or computer networking technologies, for example, Ethernet technologies. Communication module 110 may also include a local area network (LAN) or a wireless local area network (WLAN). For example, communication module 110 may include wireless computer communication technologies between processor 120 and personal device 40.

The term “network” as used herein refers to any interconnection of two or more devices (including lighting controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

When executed by processor 120, awareness module 170 also detects a signal indicative of any input by the user via a user interface. The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

Processor 120 is configured to record in the memory 130 any input entered by a user along with a snapshot of the context in which each input was entered. An input may be, for example, a selection of lighting atmosphere settings associated with a venue, a vote expressing a preference for lighting atmosphere setting associated with a venue, and/or any combination of the foregoing. The context of an adjustment may be, for example, a time of day, an intensity of the natural light, a schema, any settings prior to the request, an amount of the change, a time between a request preceding a change, a position of the user, an activity of the user before and/or after a request, a number of other people present, a temperature, a humidity level, etc.

Processor 120 communicates with local memory 130, which stores lighting setting preferences expressed by the user input, and the context in which the user input was entered. Local memory 130 associates a user identifier with the lighting setting preferences expressed by the user. Embodiments of memory 130 include various types of storage media, e.g., volatile and non-volatile computer memory such as RAM, PROM, EPROM and EEPROM, floppy disks, compact disks, optical disks, hard disks, and magnetic tape. In some implementations, the storage media may be encoded with one or more programs capable of being executed on a processor. Various storage media may be transportable, such that the one or more programs stored thereon can be loaded into a processor so as to implement various aspects of the present invention discussed herein. The terms “program” or “computer program” are used herein in a generic sense to refer to any type of computer code (e.g. software or microcode) that can be employed to program one or more processors.

When requested by processor 120, preferences database 50 stores adjustment requests and personal preference rules in association with a user identifier. A processor in accordance with the invention in another interactive system, such as interactive systems 20 and 30, may similarly store preferences expresses by user input in preferences database 50. Moreover, a processor in accordance with the invention may download and analyze information in preferences database 50 from a plurality of interactive systems to identify user preferences for different lighting settings and the contexts in which these preferences are expressed.

In exemplary embodiments of the invention, memory 100 further includes an executive module 180. Information detected by awareness module 170 is optionally collated, optionally pre-analyzed, and then transferred to executive module 180. Executive module 180 instructs processor 120 to control the individually-controllable luminaires 150 or other devices in controllable lighting network 140 based on the detected information. Executive module 180 may also receive signals identifying requested adjustments and implement the adjustments to change individually controllable luminaires 150. Processor 120 implements the personal preferences based on the user input and based on the priority of the user or personal preferences of the user. In some embodiments, controllable lighting network 140 may be composed of, for example, dedicated hardware communication links. In some other embodiments, luminaires 150 include one or more addressable luminaires which communicate through a lighting network that includes other types of communication links, for example, an Ethernet or a wireless network connection. In other embodiments of the present invention, executive module 180 may be located in local memory 130.

Processor 120 may be a lighting controller, which is used herein generally to describe various apparatus relating to the operation of one or more luminaires. A controller, including a lighting controller, may be implemented in numerous ways (e.g., such as with dedicated hardware) to perform various functions discussed herein. A controller also may be implemented as a combination of dedicated hardware to perform some functions and a processor (e.g., one or more programmed microprocessor and associated circuitry) to perform other functions. Examples of controller components that may be employed in various embodiments of the present disclosure include, but are not limited to, conventional microprocessors, application specific integrated circuits (ASICS), and field-programmable gate arrays (FPGAs).

The plurality of individually controllable luminaires 150 controlled by processor 120 include, in some embodiments of system 10, one or more luminaires that are installed in fixed locations, and are capable of communicating with processor 120 via controllable lighting network 140. In some other embodiments, individually controllable luminaires 150 may include one or more addressable luminaires which communicate through a lighting network that may include other types of communication links, for example, an Ethernet or a wireless network connection. Communications between processor 120 and controllable lighting network 140 can include control commands sent from executive module 180 of processor 120 to luminaires 150. These commands may cause one or more of luminaires 150 to, for example, turn on, turn off, decrease or increase intensity, or change the spectral power distribution of their illumination.

The term “luminaire” should be understood to refer to any of one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

A given luminaire may be configured to generate electromagnetic radiation within the visible spectrum, outside the visible spectrum, or a combination of both. Hence, the terms “light” and “radiation” are used interchangeably herein. Additionally, a luminaire may include as an integral component one or more filters (e.g., color filters), lenses, or other optical components. Also, it should be understood that luminaires may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “light source” should be understood to refer to any of one or more of a variety of radiation sources, including, but not limited to, LED-based sources, incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered to be an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

A given luminaire may be configured to generate electromagnetic radiation within the visible spectrum, outside the visible spectrum, or a combination of both. Hence, the terms “light” and “radiation” are used interchangeably herein. Additionally, a luminaire may include as an integral component one or more filters (e.g., color filters), lenses, or other optical components. Also, it should be understood that luminaires may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any of one or more frequencies (or wavelengths) of radiation produced by one or more luminaires. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources). The term “spectral power distribution” is understood to refer to the power per unit area per unit wavelength of an illumination, or the per-wavelength contribution to any radiometric quantity (e.g. radiant energy, radiant flux, radiant intensity, radiance, irradiance, radiant exitance, or radiosity).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the term “different colors” implicitly refers to multiple spectra having different wavelength components and/or bandwidths. It also should be appreciated that the term “color” may be used in connection with both white and non-white light.

According to some embodiments, the illumination proximate to personal device 40 created by luminaires 150 may be visible only through the use of technology comprising polarized spectacles and electronically shuttered spectacles. For example, luminaires 150 may repeatedly generate light pulses, technologies such as electronically shuttered spectacles may be synchronized to block the same slice of each lighting period, and luminaires 150 may be configured to shift one or more light pulses into the time slice that is shuttered or blocked.

According to some other embodiments, the illumination proximate to personal device 40 from luminaires 150 may comprise, for example, a single color light and/or a sequence of lights having different colors.

In yet other embodiments, the illumination proximate to personal device 40 created by luminaires 150 may be encoded with a modulated signal corresponding to the user identifier associated with personal device 40 or another user's personal device. In such an embodiment, personal device 40 may comprise at least one sensor for detecting the modulated signal as well as the ability to capture the modulated signal. In such an embodiment, the signal may comprise the modulated signal detected and captured by personal device 40.

In the embodiments of the invention, system 10 includes a schematizer 160 for generating a schema. Schematizer 160 creates light schemata, either from inputs from a lighting designer or from information captured from system 10. Schematizer 160 provides a schema to executive module 180 and the schema runs in executive module 180. Schematizer 160 may also modify a schema. It can receive personal preferences, via the internet, for the people who are in the space controlled by system 10, allowing control of the lighting atmosphere settings accordingly. In one embodiment of the invention, the lighting atmosphere settings may be literal settings, coded settings, or a reference to a particular schema. In another embodiment, the atmosphere can be a lighting atmosphere. In some other embodiments of the invention, an atmosphere can be a system of fragrance, sounds, music, videos, temperature control, humidity control, smoke effects, etc. In some other embodiments of the invention, system 10 may have a schematizer interface for transmitting a request for a schema to a remote schematizer, where the request includes information indicative of at least one of observed system parameters. The schematizer interface is also for receiving a schema from the remote schematizer. Local memory 130 may store observed system parameters and the schema. In some embodiments of the invention, a sensor interface is used for receiving additional observed system parameters and processor 120 is further used for modifying the schema to compensate for the additional observed system parameters.

Further, a schemata marketplace 60 is connected to system 10 and may be linked to systems 20 and 30. Marketplace 60 is used for trading lighting atmosphere settings. A network enables lighting atmosphere settings to be transmitted to multiple unrelated venues, the venues containing lighting atmosphere systems that can adapt the lighting atmosphere settings output. In some embodiments, the settings may be encoded within a setting identifier. Alternatively, in other embodiments, the atmospheres can be audiovisual, fragrance, fog, temperature, humidity and kinetic based. Such atmospheres can be instantaneous or generalized over a time period. Schematizer 160 can retrieve alternate schemata from marketplace 60 via the internet.

A processor 120 in accordance with the invention translates the schema into instructions for controlling output settings of at least one controllable lighting network. In such embodiments of the invention, executive module 180 generates a signal directed to the controllable lighting network based on an applicable schema, any applicable user preferences, and any applicable user input.

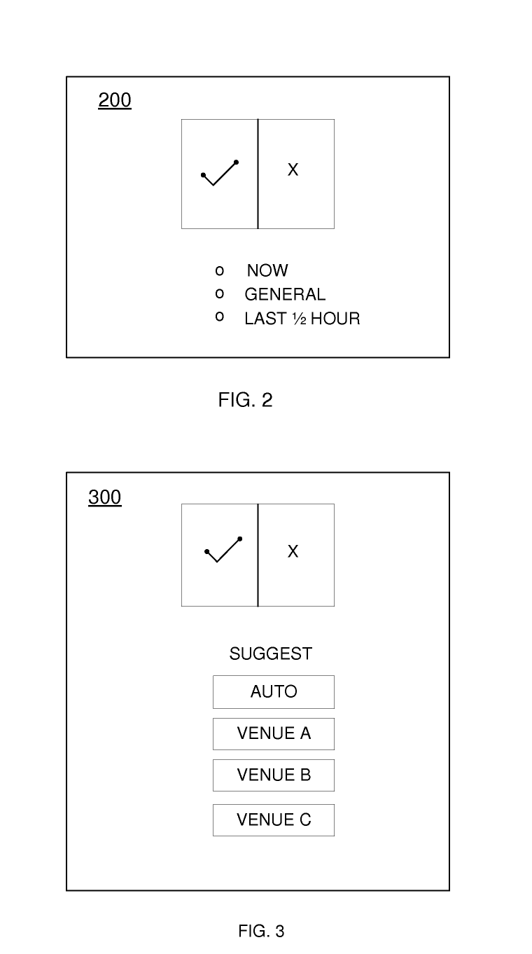

FIG. 2 illustrates an exemplary user interface 200, which may for example be a component of an application running on a mobile electronic communication device. A user in Venue A, for example, can carry a mobile device 40 that offers interface 200 and that can be identified by or identified to system 10. Alternatively, interface 200 may be a feature of Venue A. Interface 200 may be a user interface of a remote device in Venue A. When system 10 detects the user identifier via mobile device 40, schematizer 160 may retrieve the user's preferences from preference database 50 based on the user identifier. However, the schema running may not require input relating to that person's preferences. If the user likes the lighting atmosphere settings of Venue A, the user can provide a user input via interface 200, for example, by ‘clicking’ the tick symbol. Optionally, the user specifies whether he likes the lighting atmosphere settings at that moment (“NOW”), in general or over the last half an hour. Awareness module 170 detects the click, for example, with the user identifier associated with mobile device 40. Awareness module 170 may further detect the context for the user input. The context may be, but for example, the activities of the user, the location of the user, the enabled space, the number of other people present, or the time of day. The system may, for example, treat the user input as a vote. The vote is passed to executive module 180, and to schematizer 160, along with the user identifier and, in some embodiments, the context. Schematizer 160 uploads to marketplace 60, via the internet, an identifier of the atmosphere snapshot/period, together with instantaneous or a range of settings of the atmosphere system, in some embodiments, the context of the user. Information is stored in marketplace 60 in order for the atmosphere lighting settings voted for to be retrieved at a later date, either by the same venue or another venue. Moreover, if the user does not like the lighting atmosphere settings, the user can provide a different user input via interface 200, by ‘clicking’ the X symbol. The interface 200 may alternately present a series of five stars, for example, as a way to rate the lighting atmosphere.

FIG. 3 illustrates another exemplary user interface 300, which may for example be a component of an application running on a mobile electronic communication device. A user in Venue D, for example, can carry a device 40 that offers interface 300 and that can be identified by or identified to system 10. Alternatively, interface 300 may be a feature of Venue D, which offers a selection includes a variety of other venue identifiers. When system 10 detects the user identifier via mobile device 40, schematizer 160 may retrieve the user's preferences from preference database 50 based on the user identifier. Preference database 50 may contain the user's preferences for lighting atmosphere settings in venues A, B and C, which are venues with respect to which the person has previously provided input.

If the user dislikes the lighting atmosphere settings of Venue D, he can provide a user input via the interface 300, for example, by clicking on the “X”. The system 10 can treat such user input as a negative vote. Negative votes can be collected by executive module 180 and supplied to schematizer 160 for deciding how to modify the atmosphere lighting settings based on user input. The negative votes may also be transmitted to marketplace 60 for storage under the user identifier in association with the schema that is running.

Moreover, the user may use exemplary interface 300 to suggest another atmosphere's lighting atmosphere settings, by clicking on one of the displayed buttons: “AUTO”, “VENUE A”, “VENUE B” or “VENUE C”. If the user clicks “AUTO”, a signal is sent to awareness module 170 of Venue D and schematizer 160 interprets the user input as an instruction to retrieve and average, or otherwise algorithmically combine, all previously voted for atmospheres, such as Venue A, B and C. For example, schematizer 160 may select the most appropriate venue based on closest context, rather than merging the atmosphere lighting settings of two or more venues. If the user clicks “VENUE A”, the user specifies that the lighting atmosphere settings of Venue D should be changed to or towards the lighting atmosphere settings previously saved for Venue A. Schematizer 160 retrieves the atmosphere lighting settings of Venue A from the marketplace and forwards the atmosphere lighting settings to executive module 180. A payment is transferred from Venue D to Venue A via the marketplace, with the marketplace taking a percentage or a transfer fee. Depending on the running schema, the new lighting atmosphere settings are created in full or partially, immediately or over a time period, or solo or merged with other requested lighting atmosphere settings.

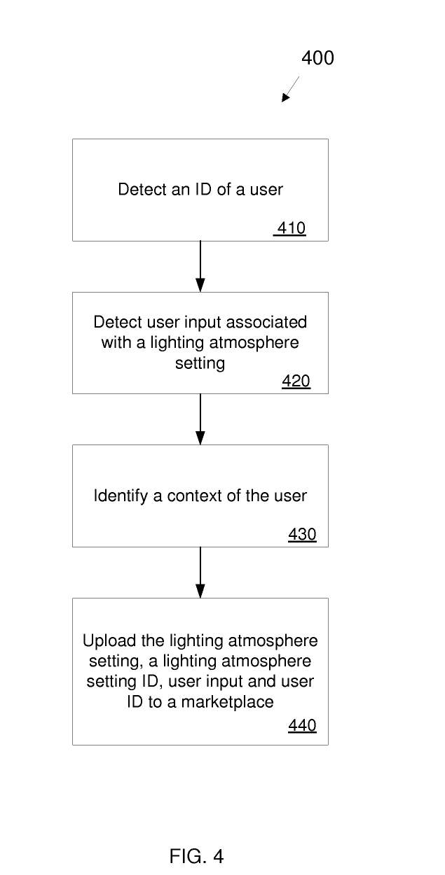

FIG. 4 illustrates a method 400 for creating a marketplace for lighting atmosphere settings, which may be implemented, for example, by system 10 consistent with an embodiment of the invention. Method 400 begins, in step 410, with awareness module 170 detecting an identifier for a user in a venue. In step 420, awareness module 170 further detects an input from the user associated with the lighting atmosphere setting of the venue and optionally may identify the context of the user in step 430. The user input is passed to executive module 180, and to schematizer 160, along with the user identifier and the context. In step 440, schematizer 160 uploads to marketplace 60, via the internet, a setting identifier of the atmosphere lighting settings, optionally with the user identifier, user input, and/or context of the user. The setting identifier could either be an identifier of the venue; an identifier of the venue in addition to an identifier of the running schema; or an identifier that incorporates a unique venue identifier. Marketplace 60 may allocate a unique lighting setting identifier, or convert a received setting identifier to a unique setting identifier.

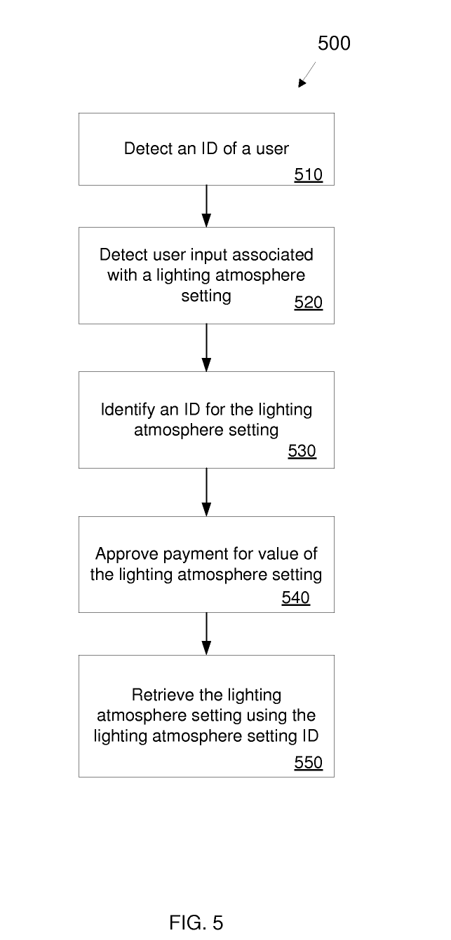

FIG. 5 illustrates a method 500 for retrieving lighting atmosphere lighting settings, which may be implemented, for example, by system 10 consistent with an embodiment of the invention. In step 510 of method 500, a user identifier is detected in a venue. The user enters an input, such as a selection, and a lighting atmosphere setting is identified based on the user input. System 10 detects the user input in step 520 and checks the preference database for the setting identifier of the lighting atmosphere setting in step 530. Then, in step 540, a payment for the lighting atmosphere settings is sent to or approved by marketplace 60 to retrieve the lighting atmosphere settings. The payment may be transmitted via a secure local or remote network connection. The payment can be made using a debit card, credit card, bank account, or another type of credit system. The user or the venue in which the user is located sends the payment to or authorizes payment to marketplace 60. Marketplace 60 forwards or authorizes the payment to the lighting designer who created the purchased lighting atmosphere settings. Alternatively, marketplace 60 may forward or authorize the payment to a consolidator or a different venue who may have ownership rights of the lighting atmosphere settings. Once the payment is authorized, accepted, or approved, the lighting atmosphere settings are retrieved from marketplace 60 in step 550.

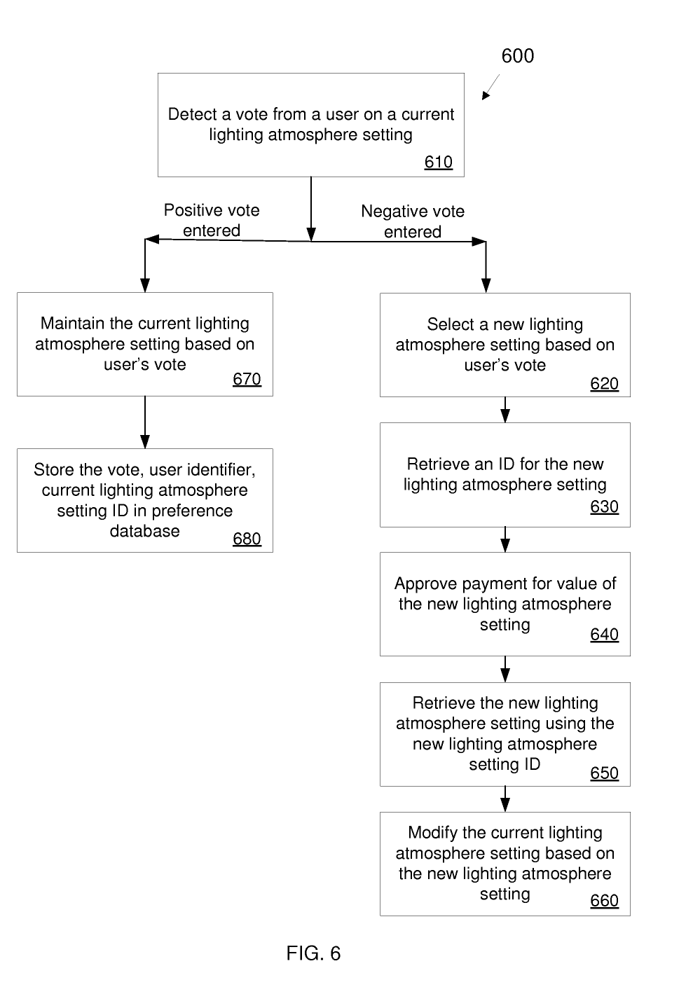

FIG. 6 illustrates a method 600 for modifying lighting atmosphere settings, which may be implemented, for example, by system 10 consistent with an embodiment of the invention. In method 600, awareness module 170 detects a user in a venue and identifies the identifier of the user. The user provides an input expressing approval or disapproval of the lighting atmosphere settings of the venue in step 610. System 10 may treat such an indication of approval or disapproval as a vote. If the user indicates approval of the lighting atmosphere settings, then system 10 maintains the lighting atmosphere settings in step 670. Optionally, the setting identifier for the lighting atmosphere settings is identified. In step 680, the user's vote, the user identifier, the lighting atmosphere settings and the setting identifier for the lighting atmosphere settings are saved in preference database 50. If the user indicates disapproval of the lighting atmosphere settings, system 10 selects a new lighting atmosphere setting based on the user's vote in step 620. Then, in step 630, the setting identifier is retrieved for the new lighting atmosphere setting from preference database 50. Payment may be sent or approved in step 640, as explained with respect to step 540 of method 500. Once the payment is provided or approved, or agreed to be provided, in step 640 to marketplace 60 for the new lighting atmosphere setting, the new lighting atmosphere setting is retrieved by using the associated setting identifier in step 650. Based on the retrieved new lighting atmosphere setting, system 10 modifies the lighting atmosphere settings of the venue in step 660.

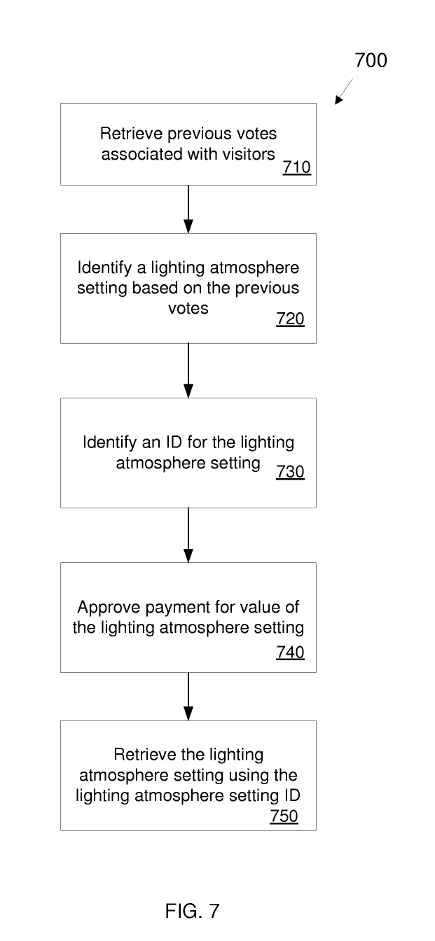

FIG. 7 illustrates a method 700 for retrieving a lighting atmosphere setting based on previous votes, which may be implemented, for example, by system 10 consistent with an embodiment of the invention. System 10 detects the user identifiers for the visitors in a venue. Using the user identifiers in step 710, system 10 retrieves votes that were previously submitted by the visitors from preference database 50. Based on the previous votes, in step 720, system 10 identifies a lighting atmosphere setting that may be acceptable to the visitors. Then, in step 730, a setting identifier for the acceptable lighting atmosphere setting is identified from preference database 50. Payment may be sent in step 740, as explained with respect to step 540 of method 500. Payment is received or approved by marketplace 60 for the value of the lighting atmosphere settings in step 740, and the lighting atmosphere setting is retrieved from marketplace 60 in step 750 to be implemented in the venue

Marketplace 60 may also store additional personal preferences or demographic data of the visitors. Accordingly, a designer selecting a lighting atmosphere setting for a new venue can base his lighting atmosphere setting decision on preferences similar to those people whom he expects would visit his space.

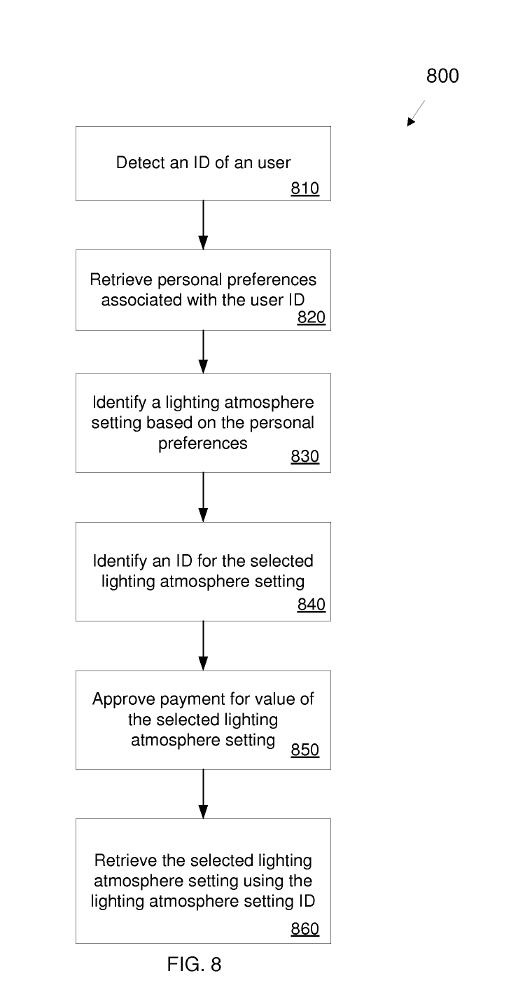

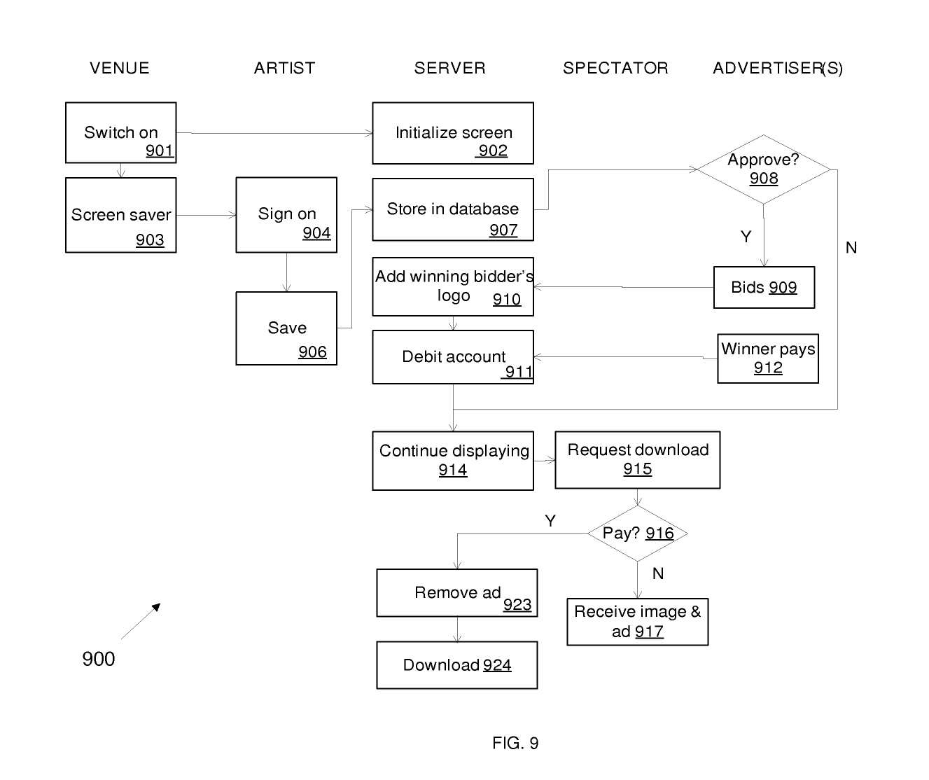

FIG. 8 illustrates a method 800 for modifying a lighting atmosphere setting based on personal preferences, which may be implemented, for example, by system 10 consistent with an embodiment of the invention. Awareness module 170 detects a user in a venue and identifies the identifier of the user in step 810 of method 800. Then, in step 820, using the user identifier, system 10 retrieves the personal preferences of that user from preference database 50. Based on the personal preferences, a lighting atmosphere setting is selected in step 830. The setting identifier for the lighting atmosphere setting is determined in step 840. Payment may be sent in step 840, as explained with respect to step 540 of method 500. After providing payment for the selected lighting atmosphere setting to marketplace 60 in step 850, the selected lighting atmosphere setting is retrieved using the setting identifier in step 860.

In some other embodiments of the invention, a large screen may be set up to display lighting-based images at a venue such as a cinema, sports stadium, shopping mall, or theatre. The screen may be configured to display lighting-based images created by artists or designers. The screen may be a touch sensitive screen, or it may be controlled by a controller device. The artist or designer selects all or most of the usual controls in a lighting-based image application program.

Further, the screen may be internet enabled, and comprises hardware including a processor and electronic memory. The screen may be connected via the internet to a server which carries a database holding images on the screen and images from the screens at other venues around the world. An artist can log in and have an account with the system. The artist may have a signature, logo or tag that is stored in a local or remote memory and can be displayed on the screen as a part of the image. Images created by the artist may be stored locally, remotely on a server, or both. Moreover, the screen may be linked to a cellular telephone network. Spectators who like the image may send a text message to a displayed number to request a download of the image to their cell phones. They may also request the image to be sent to their e-mail accounts. A payment for the image may be added to the cost of the transmission, such payment for remunerating any combination of the artist, the venue and the system provider. Alternately, the screen may be Bluetooth enabled, so that Bluetooth enabled viewers can download images direct from the screen.

In a similar embodiment, the screen may display the logo of an advertiser, or the logo of the venue, or no logo at all. Viewers may elect to download the images free of charge, in which case the images will contain the logo of an advertiser, or an advertiser's name. If the viewers elect to pay, then a clean image can be downloaded without the insertion of a logo or advertiser. Moreover, advertisers around the world may view the images contained in the database and choose which ones they want to sponsor. The provider system may include a bidding arena such that the highest bidding advertiser wins the copyright to the image and the right to advertise with it. Advertisers may also use the images, which may be compiled, to create sponsored television commercials which are more interesting to viewers than traditional commercials.

FIG. 9 illustrates a method 900 for generating revenue for lighting-based images designed in an electronic application with a display screen in a venue consistent with an embodiment of the invention. At the start of the method, the manager of the venue switches on the screen in step 901 and a processor in a server or other computer initializes the screen in step 902. Until a lighting-based image is displayed on the screen, by default the screen is in a screen saver mode in step 903. An artist then decides to log onto the system in step 904 and create a lighting-based image in step 906. The image is stored in the database in step 907. At this point, an advertiser has an opportunity to approve the image for sponsorship in step 908. If there are a group of advertisers, a bidding system can be used to grant the usage rights of the picture to the highest bidder in step 909. Bidding may be a fixed fee, a fee per download, a fee per display at a venue or any combination of these. If approved, the logo of the advertisers with the winning bid is overlaid on the image in step 910. or otherwise associated with the image, and an account for the artist is identified in step 911. The account enables payment to be collected for the artist, and may, for example, be a debit account. Then, in step 912, the winner pays the fee for sponsorship. The display of the image plus logo is continued to be displayed at the venue in step 914. A spectator with a cell phone or the like then requests to download the image in step 915. The spectator indicates whether he wants to pay for it or not in step 916. If the spectator wishes to pay, the server removes the logo in step 923 and downloads the image to the spectator's cell phone, or other specified destination in step 924. If the spectator wishes to receive the image free, the server downloads the image with the overlaid advertisement to the spectator's cell phone or other destination in step 917.

In other embodiments of the present invention, a remote viewer can view the images, vote on the images, pay to download without the logo, and print the images. During the interaction of the parties to the process, the marketplace governs the payments between the parties. Further, spectators can also vote or rate the image by SMS messaging. The screen may be configured to display the image according to a time proportional to the number of votes or the score received for the image. The score may also determine the frequency or duration for which the image is displayed in a screensaver mode.

In another embodiment of the invention, atmospheres settings are not limited to lighting atmosphere settings. Atmospheres may also be captured from gaming systems including the background music, sound effects and/or lighting and/or scenery colors. A gaming control interface can accept a user input to indicate his approval or disapproval of an atmosphere, in part or in whole, and data representing the snapshot of the game's atmosphere can be transmitted to the marketplace as above, linking to the user via his gaming profile, which is also linked to his preferences. Further, atmospheres can also be captured from internet images, video clips or broadcasts while a user is logged on to a voting application. Atmospheres in Second Life or other such games can also be voted on, stored for later use and/or sale.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. Further, the boundaries between the modules (such as schematizer, executive module or awareness module) may be moved such that functions described as being in one module may actually be performed by another module. For example, the marketplace may be embodied within the preference database, or vice verse, or they may be combined as a single module.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Although exemplary implementations have been described, the above-described methods can be implemented in any of numerous ways. For example, the methods may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device. Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tables. As another example, a computer may receive input information through speech recognition or in other audible format. Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform any of the methods described above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention. Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combination of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

Any reference numerals or other characters, appearing between parentheses in the claims, are provided merely for convenience and are not intended to limit the claims in any way.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A system for creating a marketplace of lighting atmosphere settings related to at least one controllable lighting network, the system comprising:
at least one processor configured to execute an awareness module and an executive module,
wherein the awareness module detects a user identifier and a user input associated with a set of lighting atmosphere settings, and
wherein the executive module transmits the user identifier and the user input from the awareness module to a schematizer;
the schematizer configured to upload the set of lighting atmosphere settings and a setting identifier associated with the set of lighting atmosphere settings to a marketplace; and
the marketplace configured to store the setting identifier and to enable retrieval of the set of lighting atmosphere settings in exchange for a payment.

2. The system of claim 1, wherein the awareness module further detects a context corresponding to the user identifier, and wherein the executive module further transmits the context from the awareness module to the schematizer.

3. The system of claim 1, wherein the schematizer sends the user identifier and the setting identifier to a preference database

4. The system of claim 1, wherein the schematizer retrieves personal preferences associated with the user identifier from a preference database to control the set of lighting atmosphere settings based on the personal preferences.

5. The system of claim 1, wherein the schematizer provides a schema to the executive module controlling the set of lighting atmosphere settings, and wherein the schema runs in the executive module.

6. The system of claim 1, wherein the context is selected from a group consisting of: daylight data, general color of the venue, temperature, movement of the user, time of day, number of occupants, type of venue, type of event occurring at the venue, date and personal activities.

7. A method for creating a marketplace of lighting atmosphere settings in a controllable lighting network comprising at least one memory for storing data and instructions, a lighting source, a schematizer, at least one processor configured to access the at least one memory and to execute at least one software module comprising an awareness module to perform computer-implemented steps comprising:
detecting, by the awareness module, a user identifier and a user input associated with the user identifier, the user input changing a value for a set of lighting atmosphere settings; and
uploading, by the schematizer, a setting identifier associated with the set of lighting atmosphere settings to a marketplace, the set of lighting atmosphere settings available in exchange for a payment of the value.

8. The method of claim 7, further comprising storing the user identifier and the setting identifier in the marketplace for providing an option for retrieval.

9. The method of claim 7, further comprising storing the user identifier, the user input and the setting identifier in a preference database.

10. The method of claim 7, further comprising receiving personal preferences associated with the user identifier and allowing control of the set of lighting atmosphere settings based on the personal preferences.

11. A method for retrieving lighting atmosphere settings in a controllable lighting network comprising at least one memory for storing data and instructions, a user interface, a lighting source, a schematizer, at least one processor configured to access the at least one memory and to execute a plurality of software modules, comprising an awareness module, to perform computer-implemented steps comprising:
detecting, by the awareness module, a user identifier and a user input associated with the user identifier and with a set of lighting atmosphere settings having a value;
identifying, by the schematizer, a setting identifier associated with the set of lighting atmosphere settings from a preference database;
approving, by the schematizer, a payment for the value of the set of lighting atmosphere settings; and
retrieving, by the schematizer, the set of lighting atmosphere settings using the setting identifier.

12. A method for modifying lighting atmosphere settings in a controllable lighting network comprising at least one memory for storing data and instructions, a user interface, a lighting source, and at least one processor configured to access the at least one memory and to execute a plurality of software modules, comprising an awareness module and an executive module, to perform computer-implemented steps comprising:
detecting, by the awareness module, a vote from a user, the vote associated with a first set of lighting atmosphere settings of a first venue;
receiving from the user, by the awareness module, an input associated with a second set of lighting atmosphere settings of a second venue having a value;
retrieving, by the schematizer, a setting identifier associated with the second set of lighting atmosphere settings from a preference database;
transferring, by a marketplace, a payment of the value from the first venue to the second venue;
retrieving, by the schematizer, the second set of lighting atmosphere settings using the setting identifier from the marketplace; and
modifying, by the executive module, the first set of lighting atmosphere settings based on the second set of lighting atmosphere settings.

13. The method of claim 12, further comprising storing the vote from the user as a personal preference in a personal preferences database.

14. The method of claim 12, wherein the input associated with the second set of lighting atmosphere settings comprises a vote.

15. A method for retrieving lighting atmosphere settings for a venue in a controllable lighting network comprising at least one memory for storing data and instructions, a user interface, a lighting source, a schematizer, and at least one processor configured to access the at least one memory and to execute a plurality of software modules, comprising an awareness module and an executive module, to execute computer-implemented steps comprising:
detecting, by the awareness module, at least one user identifier of at least one user visiting the venue;
retrieving, by the schematizer, at least one lighting setting vote associated with the at least one user identifier from a preference database;
identifying, by the schematizer, a set of lighting atmosphere settings for the venue based on the at least one lighting setting vote, the set of lighting atmosphere settings having a value;
retrieving, by the schematizer, a setting identifier associated with the set of lighting atmosphere settings from the preference database;
approving, by the schematizer, a payment for the value of the set of lighting atmosphere settings to a marketplace; and
retrieving, by the schematizer, the set of lighting atmosphere settings from the marketplace using the setting identifier.

16. The method of claim 15, wherein the executive module controls the venue based on the set of lighting atmosphere settings.

17. A system for generating revenue from lighting-based images linked to a communication network, the system comprising:
at least one processor configured to execute a display module, a transfer engine, and a payment engine,
wherein the display module displays a lighting-based image created by a first user,
wherein the transfer engine transmits the lighting-based image to a second user, and
wherein the payment engine requests payment from the second user for the lighting-based image transmission; and
a memory configured to store the lighting-based image.

18. The system of claim 17, further comprising a communication link for the second user to request the lighting-based image.

19. The system of claim 17, wherein the second user requests the lighting-based image to a mobile device.

20. The system of claim 17, wherein the second user requests the lighting-based image to a personal communication account.

21. The system of claim 17, wherein the first user has an account associated with a user signature, user logo or user tag.

22. The system of claim 17, wherein the display module is Bluetooth enabled, and the second user downloads the image from the display module using the Bluetooth.
